(19) United States
(12) Patent Application Publication
(10) Pub. No.: US 2025/0317688 A1
(43) Pub. Date: Oct. 9, 2025

(54) SPEAKERS

(71) Applicant: SHENZHEN SHOKZ CO., LTD., Shenzhen (CN)

(72) Inventors: Chaojie CUI, Shenzhen (CN); Hao KE, Shenzhen (CN)

(73) Assignee: SHENZHEN SHOKZ CO., LTD., Shenzhen (CN)

(21) Appl. No.: 19/241,428

(22) Filed: Jun. 18, 2025

Related U.S. Application Data
(63) Continuation of application No. PCT/CN2023/107474, filed on Jul. 14, 2023.

(51) Int. Cl. H04R 7/06; H04R 7/18; H04R 9/02; H04R 9/04; H04R 9/06

(52) U.S. Cl. CPC H04R 7/06; H04R 7/18; H04R 9/025; H04R 9/045; H04R 9/06

(57) ABSTRACT

A speaker is provided. The speaker includes: a support portion, a magnetic circuit assembly, and a positioning assembly. The magnetic circuit assembly is connected to the support portion through the positioning assembly, and the magnetic circuit assembly vibrates relative to the support portion; and the positioning assembly includes two vibration transmission plates spaced apart in a vibration direction of the magnetic circuit assembly, and projections of the two vibration transmission plates along the vibration direction are symmetrical with each other.

### CROSS-REFERENCE TO RELATED APPLICATIONS

This application is a Continuation of International Application No. PCT/CN2023/107474, filed on Jul. 14, 2023, the entire contents of which are hereby incorporated by reference.

### TECHNICAL FIELD

The present disclosure relates to the technical field of acoustic output devices, and in particular to a speaker.

### BACKGROUND

A vibration transmission plate, as an important member in a bone conduction speaker, is able to transmit vibrations generated by a bone conduction vibration transducer in a bone conduction speaker to a housing, and then the vibrations are transmitted to auditory nerves of a user through a human skin, subcutaneous tissues, and bones, so that the user hears the sound. Usually, the bone conduction vibration transducer of the bone conduction speaker is prone to vibrate in a direction that deviates from the expected vibration direction, and the vibration transducer is likely to collide with the housing or a coil. Then, the vibration transmission plate would be affected by the vibration of the bone conduction vibration transducer that deviates from the expected vibration direction, and it is more likely to crack.

Therefore, it is necessary to propose a speaker with an improved structural reliability.

### SUMMARY

One of the embodiments of the present disclosure provides a speaker, the speaker includes: a support portion, a magnetic circuit assembly, and a positioning assembly. The magnetic circuit assembly is connected to the support portion through the positioning assembly, and the magnetic circuit assembly vibrates relative to the support portion; and the positioning assembly includes two vibration transmission plates spaced apart in a vibration direction of the magnetic circuit assembly, and projections of the two vibration transmission plates along the vibration direction are symmetrical with each other.

One of the embodiments of the present disclosure further provides a speaker including: a support portion, a magnetic circuit assembly, and a positioning assembly. The magnetic circuit assembly is connected to the support portion through the positioning assembly, and the magnetic circuit assembly vibrates relative to the support portion; and the positioning assembly includes two vibration transmission plates spaced apart along a vibration direction of the magnetic circuit assembly, and projections of the two vibration transmission plates along the vibration direction are asymmetrical with each other.

Additional features will be set forth in part in the following description and will become apparent to those skilled in the art by consulting the following and the accompanying drawings, or may be appreciated by the production or operation of examples. Features of the present disclosure may be realized and obtained by practicing or using aspects of the manners, tools, and combinations set forth in the following detailed examples.

### BRIEF DESCRIPTION OF THE DRAWINGS

The present disclosure will be further illustrated by way of exemplary embodiments, which are described in detail by means of the accompanying drawings. These embodiments are not limiting, and in these embodiments, the same numbering denotes the same structure, wherein:

FIG. 1 is a schematic diagram illustrating a frame of a speaker according to some embodiments of the present disclosure;

FIG. 2 is a schematic diagram illustrating a structure of a speaker according to some embodiments of the present disclosure;

FIG. 3 is a schematic diagram illustrating four distributions of vibration transmission plates according to some embodiments of the present disclosure;

FIG. 4 is a schematic diagram illustrating a structure of a first vibration transmission plate according to some embodiments of the present disclosure;

FIG. 5A is a schematic diagram illustrating a structure of a first vibration transmission plate according to some embodiments of the present disclosure;

FIG. 5B is a schematic diagram illustrating a structure of a first vibration transmission plate according to some embodiments of the present disclosure;

FIG. 6A is a schematic diagram illustrating a structure of a first vibration transmission plate according to some embodiments of the present disclosure;

FIG. 6B is a schematic diagram illustrating a structure of a first vibration transmission plate according to some embodiments of the present disclosure;

FIG. 6C is a schematic diagram illustrating a structure of a first vibration transmission plate according to some embodiments of the present disclosure;

FIG. 6D is a schematic diagram illustrating a structure of a first vibration transmission plate according to some embodiments of the present disclosure;

FIG. 7 is a curve diagram illustrating frequency responses of a speaker using the vibration transmission plates shown in FIGS. 6B-6D, respectively;

FIG. 8 is a schematic diagram illustrating three distributions of vibration transmission plates according to some embodiments of the present disclosure;

FIG. 9 is a schematic diagram illustrating three distributions of vibration transmission plates according to some embodiments of the present disclosure;

FIG. 10A is a schematic diagram illustrating a structure of a vibration transmission plate according to some embodiments of the present disclosure; and

FIG. 10B is a schematic diagram illustrating a structure of another vibration transmission plate according to some embodiments of the present disclosure.

### DETAILED DESCRIPTION

To more clearly illustrate the technical solutions of the embodiments of the present disclosure, the accompanying drawings required to be used in the description of the embodiments are briefly described below. Obviously, the accompanying drawings in the following description are only some examples or embodiments of the present disclosure, and it is possible for those skilled in the art to apply the present disclosure to other similar scenarios in accordance with these drawings without creative labor. It should be understood that these exemplary embodiments are given only to enable those skilled in the art to better understand and thus realize the present disclosure, and are not intended to limit the scope of the present disclosure in any way. Unless obviously obtained from the context or the context illustrates otherwise, the same numeral in the drawings refers to the same structure or operation.

As shown in the present disclosure and the claims, unless the context clearly suggests an exception, the words “one,” “a,” “an,” and/or “the” do not refer to the singular, but may also include the plural. In general, the terms “comprise,” “comprises,” and/or “comprising,” “include,” “includes,” and/or “including,” merely prompt to include operations and elements that have been clearly identified, and these operations and elements do not constitute an exclusive listing. The methods or devices may also include other operations or elements. The term “based on” means “based at least in part on.” The term “one embodiment” means “at least one embodiment”; the term “another embodiment” means “at least one other embodiment”.

In the description of the present disclosure, it is to be understood that the terms “front,” “rear,” “ear hook,” “rear hanger” etc., indicate an orientation or a positional relationship based only on what is shown in the accompanying drawings, and are used only for the purpose of facilitating the description of the present disclosure and simplifying the description, and are not intended to indicate or imply that the device or element referred to must have a particular orientation, be constructed and operated in a particular orientation, or be operated in a particular manner, and therefore are not to be construed as a limitation of the present disclosure.

Additionally, the terms “first” and “second” are used for descriptive purposes only and are not to be construed as indicating or implying relative importance or implicitly specifying the number of technical features indicated. Thus, a feature defined by “first,” “second” may expressly or implicitly include at least one of the features. In the description of the present disclosure, “plurality” means at least two, e.g., two, three, etc., unless explicitly and in some embodiments limited otherwise.

In the present disclosure, unless otherwise expressly specified or limited, the terms “mounted,” “connected,” “related,” “fixed,” etc., are to be understood in a broad sense, for example, as a fixed connection, a removable connection, or a one-piece connection, a mechanical connection, an electrical connection, a direct connection, an indirect connection through an intermediate medium, a connection within two components, or a connection between two components, or a connection between two components, unless otherwise expressly limited. For those skilled in the art, the specific meanings of the above terms in the present disclosure may be understood on a case-by-case basis.

Embodiments of the present disclosure provide a speaker including a support portion, a magnetic circuit assembly, and a positioning assembly. The magnetic circuit assembly is connected to the support portion through the positioning assembly, and the positioning assembly includes a first vibration transmission plate and a second vibration transmission plate spaced apart in a vibration direction of the magnetic circuit assembly. Projections of the first vibration transmission plate and the second vibration transmission plate along the vibration direction are symmetrical with each other. When the magnetic circuit assembly vibrates relative to the support portion, the first vibration transmission plate and the second vibration transmission plate transmit vibrations to the support portion, the support portion then transmits the vibration through the skin, subcutaneous tissues, and bones of a user to auditory nerves of the user, enabling the user to hear sound. If a single vibration transmission plate structure is used, the magnetic circuit assembly tends to deviate from the vibration direction when vibrating, and may collide with other members of the speaker (such as the housing or a coil). At the same time, when the magnetic circuit assembly deviates from the vibration direction, the vibration transmission plate may flip under an effect of the vibration of the magnetic circuit assembly. When the vibration transmission plate is shaped in a long axis direction and a short axis direction, for example, the vibration transmission plate is in a runway structure, the vibration transmission plate may flip around the long axis direction and the short axis direction, resulting in an easy fracture of the vibration transmission plate. The speaker of the embodiments of the present disclosure is provided with vibration transmission plates on both sides of the magnetic circuit assembly along the vibration direction of the magnetic circuit assembly, and the vibration direction of the magnetic circuit assembly is constrained by the vibration transmission plates on both sides. On the one hand, shakings of the magnetic circuit assembly are reduced when vibrating, and on the other hand, an amplitude of flipping of the vibration transmission plates around its own long axis direction or short axis direction may be reduced by setting the two vibration transmission plates, so that the time before the vibration transmission plates are damaged by fracture is extended substantially, and a service life of the vibration transmission plates may be ensured.

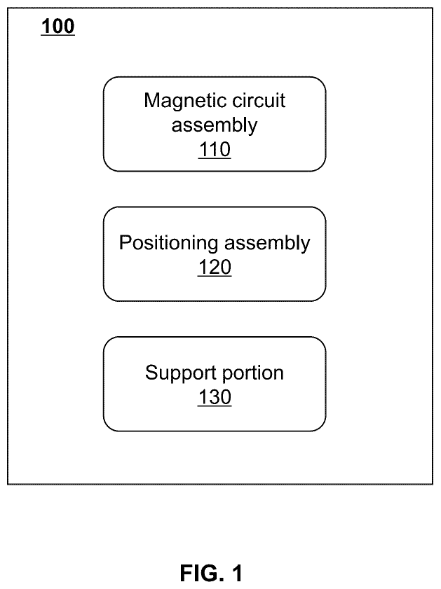

FIG. 1 is a schematic diagram illustrating a frame of a speaker according to some embodiments of the present disclosure.

As shown in FIG. 1, a speaker 100 includes a magnetic circuit assembly 110, a positioning assembly 120, and a support portion 130. The magnetic circuit assembly 110 is connected to the support portion 130 through the positioning assembly 120, and the support portion 130 is configured to carry the magnetic circuit assembly 110, the positioning assembly 120, and other elements in the speaker 100.

In some embodiments, the magnetic circuit assembly 110 is connected to the support portion 130 through the positioning assembly 120, which includes at least one vibration transmission plate. The magnetic circuit assembly 110 may generate mechanical vibrations along a vibration direction in response to electrical signals. The mechanical vibrations generated by the magnetic circuit assembly 110 may be transmitted to a positioning assembly, and transmitted to the support portion 130 (e.g., a housing) through the positioning assembly 120. A part of the structure of the support portion 130 (e.g., a side of the housing or a vibration panel) contacts the user's skin while the user is wearing the speaker 100. The support portion 130 applies the mechanical vibrations through the skin, bones, and/or tissues of the user to the user's auditory nerve, thereby enabling the user to hear sound.

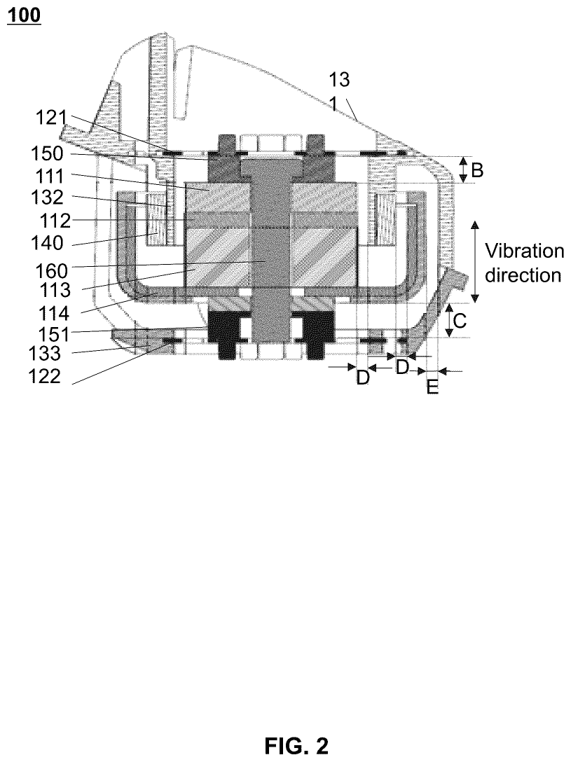

FIG. 2 is a schematic diagram illustrating a structure of a speaker according to some embodiments of the present disclosure. Combining FIG. 1 and FIG. 2, in some embodiments, the support portion 130 includes a housing 131, and an accommodation cavity is formed in the housing 131 for accommodating the magnetic circuit assembly 110 and the positioning assembly 120. In some embodiments, the positioning assembly 120 is connected to both the housing 131 and the magnetic circuit assembly 110 to suspend the magnetic circuit assembly 110 within the accommodation cavity of the housing 131. When a user wears the speaker 100, a sidewall of the housing 131 (e.g., the vibration panel of the housing facing a human face) contacts the human body, and mechanical vibrations generated by the magnetic circuit assembly 110 are transmitted to the housing 131 and to the user through the sidewall of the housing 131 contacting the human body, thereby realizing a conduction of bone conduction sound waves. In some embodiments, the support portion 130 includes the housing 131 and a vibration panel (not shown in FIG. 2). The magnetic circuit assembly 110 and the positioning assembly 120 are disposed in the accommodation cavity of the housing 131, and the vibration panel is connected to the positioning assembly 120. When the user wears the speaker 100, the vibration panel contacts the human body, and the mechanical vibrations generated by the magnetic circuit assembly 110 are transmitted to the vibration panel, and are transmitted to the user through the vibration panel that contacts the human body, thereby realizing the conduction of the bone conduction sound waves. It is to be known that the housing 131 is a cuboid, a cylinder, a stage decoupling strand, etc., or any irregularly shapes, or combinations thereof, which is not limited to the shape shown in the figures.

In some embodiments, the positioning assembly 120 includes two vibration transmission plates (a first vibration transmission plate 121 and a second vibration transmission plate 122 shown in FIG. 2). The two vibration transmission plates are spaced apart along a vibration direction of the magnetic circuit assembly 110, the two vibration transmission plates are located on opposite sides of the magnetic circuit assembly 110 along the vibration direction, and projections of the two vibration transmission plates along the vibration direction are symmetrical with each other, i.e., having symmetry. Both sides of the magnetic circuit assembly 110 along the vibration direction are connected to the support portion 130 through the vibration transmission plates.

As the two vibration transmission plates are disposed apart from each other along the vibration direction and are not in a same plane, it is the two projections of the two vibration transmission plates along the vibration direction that are symmetrically distributed with respect to each other, which in fact reflects the distribution manner of the two vibration transmission plates. In some embodiments, the vibration transmission plates are runway-shaped, rectangular, elliptical, circular, rhombic, or polygonal, etc., or have any irregular shape, or in any combination thereof. To more clearly illustrate that the two projections of the two vibration transmission plates along the vibration direction are symmetrically distributed with respect to each other, the vibration transmission plates being runway-shaped is taken as an example. When the vibration transmission plates are runway-shaped, each of them has a long axis direction and a short axis direction. In some embodiments, that the two projections of the two vibration transmission plates along the vibration direction are symmetrically distributed includes that the two projections are symmetrical along the long axis. The two projections being symmetrical along the long axis is understood as when one of the two vibration transmission plates is flipped by 180° around the long axis, the two projections of the two vibration transmission plates along the vibration direction coincide with each other. In some embodiments, that the two projections of the two vibration transmission plates along the vibration direction are symmetrically distributed includes that the two projections are symmetrical along the short axis. The two projections being symmetrical along the short axis is understood as when one of the two vibration transmission plates is flipped by 180° around the short axis, the two projections of the two vibration transmission plates along the vibration direction coincide with each other. In some embodiments, that the two projections of the two vibration transmission plates along the vibration direction are symmetrically distributed includes that the two projections are centrally symmetrical. The two projections being centrally symmetrical is understood as when one of the two vibration transmission plates is flipped by 180° around the long and short axes, respectively, the two projections of the two vibration transmission plates along the vibration direction coincide with each other. Taking the vibration transmission plates being circular as an example, each of the vibration transmission plates has a first radial direction and a second radial direction that are perpendicular to each other. The two projections of the two vibration transmission plates along the vibration direction may be symmetrically distributed along the first radial direction, symmetrically distributed along the second radial direction, or centrally distributed. For ease of description, the following is illustrated with the vibration transmission plates in the runway shape as an example.

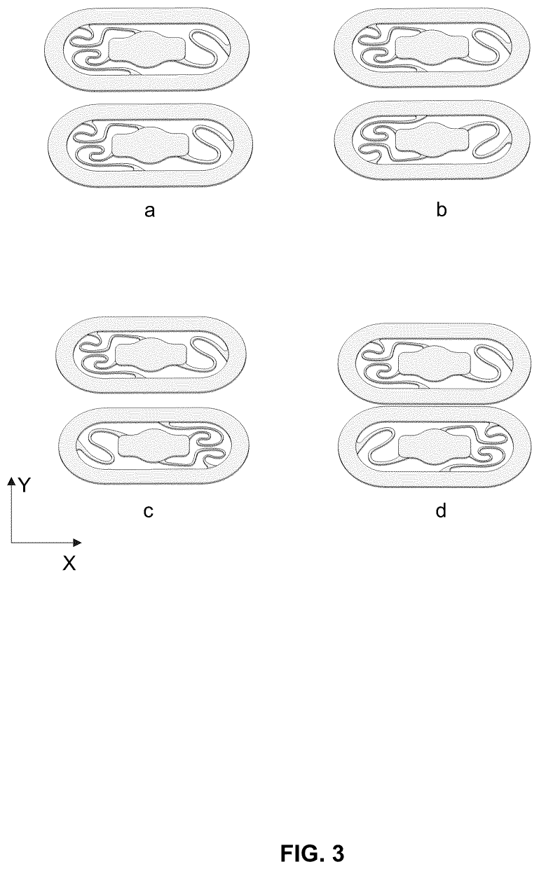

FIG. 3 is a schematic diagram illustrating four distributions of vibration transmission plates according to some embodiments of the present disclosure. As shown in FIG. 3, the vibration transmission plates are runway-shaped, and each of the vibration transmission plates has a long axis direction (i.e., the X direction shown in FIG. 3) and a short axis direction (i.e., the Y direction shown in FIG. 3). Projections of the two vibration transmission plates illustrated in region a of FIG. 3 along a vibration direction overlap with each other. Projections of the two vibration transmission plates illustrated in region b of FIG. 3 along the vibration direction are symmetrical along the long axis direction. Projections of the two vibration transmission plates illustrated in region c of FIG. 3 along the vibration direction are centrally symmetrical. The center refers to the geometric center of a peripheral contour of the vibration transmission plate. Projections of the two vibration transmission plates illustrated in region d of FIG. 3 along the vibration direction are symmetrical along the short axis.

To compare service lives of the dual-vibration transmission plates in the four distributions shown in FIG. 3, fatigue resistance testing experiments are performed on a speaker provided with a single vibration transmission plate and speakers provided with the dual-vibration transmission plates in the four distributions shown in FIG. 3. The fatigue here refers to a whole process of crack initiation and expansion leading to fracture failure due to variable load in a working process of the vibration transmission plates. In the experiment, a count of failure cycles is configured to characterize a fatigue resistance of the vibration transmission plate. The count of failure cycles may be measured by a roller test, for example, by a fatigue tester that applies a certain load for measurement in the long axis direction, the short axis direction, or a vertical axis (perpendicular to the long axis direction and the short axis direction) of the vibration transmission plates. Applying a certain load along the long axis direction, the short axis direction, or the vertical axis direction of the single vibration transmission plate and the dual-vibration transmission plates in the four distributions, the corresponding counts of failure cycles were measured, and the specific results are shown in Table 1. The greater the count of failure cycles, the better the fatigue resistance, and the longer the service life. It should be noted that the count of failure cycles measured in Table 1 is obtained based on a count of cycles at which the single vibration transmission plate breaks or the first of the two vibration transmission plates breaks.

TABLE 1
Count of failure cycles

| | Single | Distri- | Distri- | Distri- | Distri- |
|---|---|---|---|---|---|
| | vibration | bution | bution | bution | bution |
| | transmission | manner a | manner b | manner c | manner d |
| | plate | in FIG. 3 | in FIG. 3 | in FIG. 3 | in FIG. 3 |
| Long | 13.8 | 6.06 × 10⁵ | 6.42 × 10⁴ | 2.73 × 10⁵ | 9.21 × 10⁵ |
| axis | | | | | |
| load | | | | | |
| Short | 439 | 6.98 × 10⁶ | 4.38 × 10⁶ | 1.46 × 10⁶ | 1.23 × 10⁶ |
| axis | | | | | |
| load | | | | | |
| Vertical | 73500 | 2.41 × 10⁶ | 2.36 × 10⁶ | 2.16 × 10⁶ | 2.38 × 10⁶ |
| axis | | | | | |
| load | | | | | |

As may be seen from Table 1, the fatigue resistance of the two vibration transmission plates whose projections along the vibration direction overlap (the distribution manner in FIG. 3a) is much greater than the fatigue resistance of the single vibration transmission plate along the long axis direction, the short axis direction, and the vertical axis direction. Structurally, both sides of the magnetic circuit assembly 110 along the vibration direction are limited by the vibration transmission plate, which is conducive to reducing a sway of the magnetic circuit assembly 110 in a direction deviating from the vibration direction when vibrating, thereby preventing the magnetic circuit assembly 110 from colliding with the support portion and a coil, etc., of the speaker 100 when vibrating, and an acoustic output effect of the speaker 100 is ensured. Further, for the two vibration transmission plates whose projections along the vibration direction are symmetrical along the long axis direction, the two vibration transmission plates whose projections along the vibration direction are symmetrical along the short axis direction, and the two vibration transmission plates whose projections along the vibration direction are centrally symmetrical, fatigue resistances along the long axis direction, the short axis direction, and the vertical direction (i.e., the vibration direction) thereof are significantly better than the fatigue resistance of the single vibration transmission plate. Regarding the overall fatigue resistance of the vibration transmission plate, the fatigue resistance in the long axis direction is slightly poorer than the fatigue resistance in the short axis direction and the vertical axis direction. To avoid cracking or fracture in the long axis direction of the vibration transmission plate, focus on the fatigue resistance in the long axis direction is particularly considered when using two vibration transmission plates. The two vibration transmission plates whose projections along the vibration direction are symmetrical along the short axis direction (the distribution manner d in FIG. 3) have better fatigue resistance in the long axis direction than the single vibration transmission plate, the two vibration transmission plates whose projections along the vibration direction overlap, the two vibration transmission plates whose projections along the vibration direction are symmetrical along the long axis direction, and the two vibration transmission plates whose projections along the vibration direction are centrally symmetrical. In some embodiments, to further improve the fatigue resistance in the long axis direction of the vibration transmission plate, and to ensure that the vibration transmission plates has a longer service life, the two projections of the two vibration transmission plates along the vibration direction may be distributed symmetrically along the short axis direction of the vibration transmission plates.

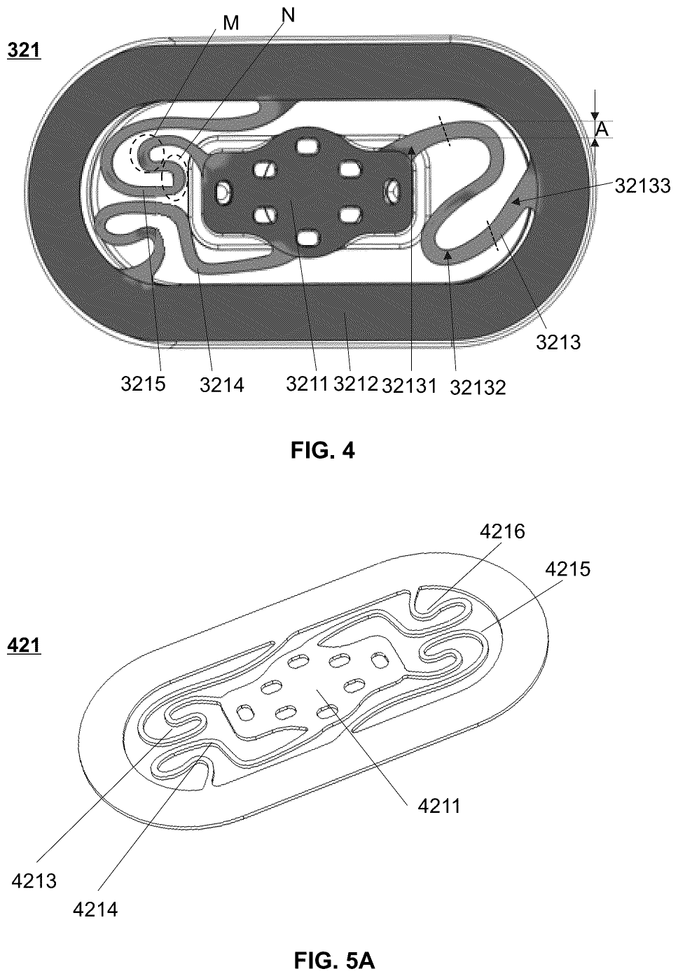

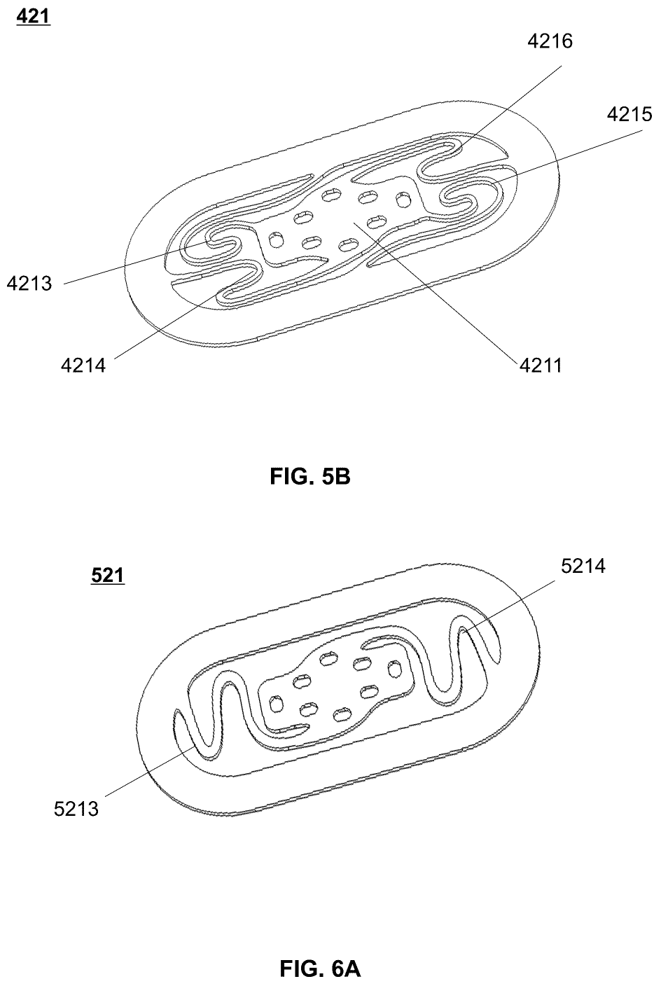

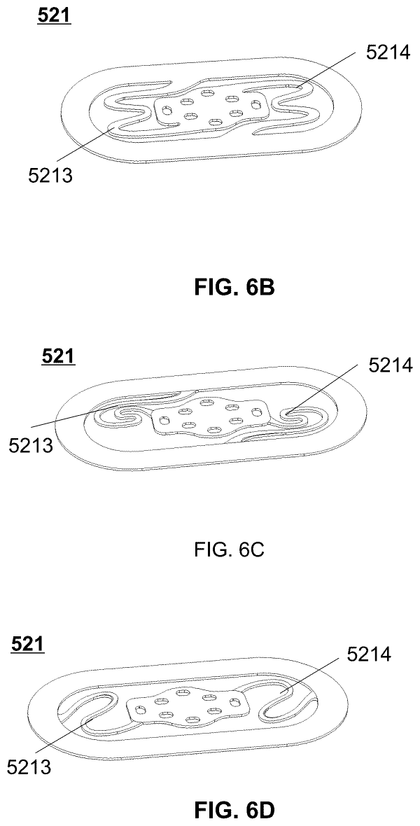

It is appreciated that the two projections of the two vibration transmission plates along the vibration direction included in the speaker 100 are not limited to being symmetrically distributed, and in some embodiments, the two vibration transmission plates are two vibration transmission plates with different body shapes. For example, one of the vibration transmission plates is a circular structure and the other vibration transmission plate is a runway-shaped structure. In some embodiments, the two vibration transmission plates are two vibration transmission plates with the same body shape and different internal structures. For example, one of the vibration transmission plates is a three connection rod structure as shown in FIG. 4, and the other vibration transmission plate is a four connection rod structure as shown in FIGS. 5A-5B, or a two connection rod structure as shown in FIGS. 6A-6D. As another example, the shapes of the connection rods (e.g., bending shapes) of the two vibration transmission plates are different. For a further example, the connection rods of the two vibration transmission plates have different width dimensions. The width dimension refers to a dimension in a direction perpendicular to an extension direction of the connection rod (referring to the dimension A shown in FIG. 4). Specific descriptions of the vibration transmission plate structure may be found in FIGS. 4-6D and related descriptions thereof.

In some embodiments, the two vibration transmission plates include a first vibration transmission plate. FIG. 4 is a schematic diagram illustrating a structure of a first vibration transmission plate according to some embodiments of the present disclosure. As shown in FIG. 4, a first vibration transmission plate 321 includes a center region 3211 and an edge region 3212. The edge region 3212 is distributed on a periphery of the center region 3211, i.e., the edge region 3212 is disposed around the center region 3211, and the center region 3211 is connected to the edge region 3212 through a connection rod (e.g., a first connection rod 3213, a second connection rod 3214, and a third connection rod 3215). One end of the connection rod is connected to an outer edge of the edge region 3212, and the other end of the connection rod is connected to an inner edge of the edge region 3212. When the magnetic circuit assembly 110 is connected to the support portion 130 through the first vibration transmission plate 321, the magnetic circuit assembly 110 is connected to the center region 3211, and the edge region 3212 is connected and fixed to the support portion 130.

In some embodiments, the edge region 3212 of the first vibration transmission plate 321 is annular. In some embodiments, a shape (an outer contour shape) of the edge region 3212 is a runway shape as shown in FIG. 4, or a regular or irregular shape such as a circle, an oval, a triangle, a quadrilateral, a pentagon, a hexagon, etc. It should be noted that the vibration transmission plates being in a runway shape is understood to mean that the edge region 3212 of the vibration transmission plates 321 is an annular structure in the runway shape. In some embodiments, an inner contour shape and the outer contour shape of the edge region 3212 are the same. For example, the outer contour shape of the edge region 3212 is the runway shape, and the inner contour shape of the edge region 3212 is also the runway shape. In some embodiments, the inner contour shape and the outer contour shape of the edge region 3212 are different shapes. For example, the outer contour shape of the edge region 3212 is the runway shape, while the inner contour shape of the edge region 3212 is other shapes such as the circle, the rectangle, etc.

In some embodiments, the center region 3211 is disposed within a hollow region of the edge region 3212, and the center region 3211 is of a structure symmetrical along the short axis and the long axis as shown in FIG. 4. In some embodiments, a region between the center region 3211 and the edge region 3212 is in a shape symmetrical along the short axis and symmetrical along the long axis as shown in FIG. 4. In some embodiments, a shape of the center region 3211 is the circle, the triangle, the quadrilateral, the pentagon, the hexagon, or other regular or irregular shapes. In some embodiments, the shape of the center region 3211 is the same as the shape of the edge region 3212. For example, the shape of the edge region 3212 and the center region 3211 are both circular, i.e., the edge region 3212 and the center region 3211 form concentric circles. In some embodiments, the magnetic circuit assembly 110 is connected to one of surfaces of the center region 3211, and a connection manner includes, but is not limited to, gluing, welding, snapping, pinning, bolting, etc.

In some embodiments, the connection rod is located between the edge region 3212 and the center region 3211, and when the vibration transmission plates are in a working state, a vibration of the magnetic circuit assembly 110 drives a part of the structure of the vibration transmission plates (e.g., the center region 3211) to vibrate along a direction perpendicular to a plane where the vibration transmission plates is located (i.e., a direction perpendicular to the page in FIG. 3), so that the vibration generated by the magnetic circuit assembly 110 is transmitted to the support portion 130, and the vibration of the support portion 130 is transmitted to auditory nerves of a user through bones, blood, muscles, etc., of the head of the user, so that the user hears the sound.

In some embodiments, there are a plurality of connection rods for realizing the connection between the edge region 3212 and the center region 3211. In some embodiments, 2-5 connection rods may be provided, to ensure the stability of the first vibration transmission plate 321 during operation, so that the magnetic circuit assembly 110 is not prone to deviation when vibrating along the vibration direction, and has a greater reliability. The deviation refers to that when the magnetic circuit assembly 110 vibrates, an actual vibration direction of the magnetic circuit assembly 110 does not coincide with the vibration direction shown in FIG. 2. For example, there is an angle between the actual vibration direction and the vibration direction shown in FIG. 2, resulting in a plane where the edge region 3212 is located and a plane where the center region 3211 is located not being parallel, i.e., in an abnormal state where there is an angle between the two planes. In this state, on the one hand, a collision between the magnetic circuit assembly 110 and other components of the speaker 100 may occur, which affects an acoustic output effect; and on the other hand, the vibration transmission plates flip around the long axis direction and the short axis direction, which makes the connection rod break easily and affects the service life of the vibration transmission plates.

In some embodiments, the plurality of connection rods include a first connection rod 3213, a second connection rod 3214, and a third connection rod 3215, as illustrated in FIG. 4. The first connection rod 3213, the second connection rod 3214, and the third connection rod 3215 are connected between the outer edge of the center region 3211 and the inner edge of the edge region 3212. In some embodiments, the first connection rod 3213, the second connection rod 3214, and the third connection rod 3215 are spaced apart along a circumference of the center region 3211. In some embodiments, the connection rod adopts a meandering bend structure. The meandering bend structure includes a plurality of bend structures (e.g., the bend structure M and the bend structure N shown in the dashed box in FIG. 4). The bend structures are curved so that the connection rod has a preset elasticity coefficient. In some embodiments, the first connection rod 3213 has two bend structures, i.e., in a continuous two-bend shape. The second connection rod 3214 has four bend structures, i.e., in a continuous four-bend shape, and the third connection rod 3215 has three bend structures, i.e., in a continuous three-bend shape. By adopting the bend structure, the elasticity coefficient of the connection rod in a particular direction (e.g., the long axis direction) may be reduced to make the connection rod more resilient and increase a deformation capacity of the vibration transmission plate, so as to effectively reduce an impact of the load on the connection rod in the particular direction, and thus improve the service life of the first vibration transmission plate 321.

In some embodiments, the first connection rod 3213, the second connection rod 3214, and the third connection rod 3215 are distributed asymmetrically. The asymmetrical distribution here refers to that the first connection rod 3213, the second connection rod 3214, and the third connection rod 3215 are neither symmetrically distributed along a centerline in the long axis direction of the vibration transmission plates nor symmetrically distributed along the short axis of the vibration transmission plate.

In some embodiments, with reference to FIG. 4, shapes and bending degrees of the bend structures of the first connection rod 3213, the second connection rod 3214, and the third connection rod 3215 are different, and two adjacent connection rods are differently spaced around a circumference of the center region 3211. The asymmetrical distribution of the three connection rods effectively solves a problem of collision within the housing 131 and a generation of noise when the magnetic circuit assembly 110 connected to the center region 3211 sways.

It should be noted that the count of connection rods in FIG. 4 is used for exemplary descriptions only and does not constitute a limitation thereon. In some embodiments, there are two or more than three connection rods in the first vibration transmission plate 321, e.g., the vibration transmission plates also include a fourth connection rod and/or a fifth connection rod.

FIG. 5A is a schematic diagram illustrating a structure of a first vibration transmission plate according to some embodiments of the present disclosure. FIG. 5 B is a schematic diagram illustrating a structure of a first vibration transmission plate according to some embodiments of the present disclosure. FIG. 5A and FIG. 5B illustrate two embodiments where the first vibration transmission plate 421 includes a first connection rod 4213, a second connection rod 4214, a third connection rod 4215, and a fourth connection rod 4216. In some embodiments, the first connection rod 4213, the second connection rod 4214, the third connection rod 4215, and the fourth connection rod 4216 adopt a bend structure shown in FIGS. 5A and 5B. In some embodiments, as shown in FIG. 5A, the first connection rod 4213 has 3 bend structures, the second connection rod 4214 has 4 bend structures, the third connection rod 4215 has 3 bend structures, and the fourth connection rod 4216 has 4 bend structures. As shown in FIG. 5B, the first connection rod 4213 has 3 bend structures, the second connection rod 4214 has 2 bend structures, the third connection rod 4215 has 3 bend structures, the fourth connection rod 4216 has 2 bend structures. In some embodiments, the first connection rod 4213 and the third connection rod 4215 have the same bend structure, the second connection rod 4214 and the third connection rod 4215 have the same bent structure, the first connection rod 4213 and third connection rod 4215 are centrally symmetrical about the first vibration transmission plate 421, the second connection rod 4214 and third connection rod 4215 are centrally symmetrical about the first vibration transmission plate 421, and two adjacent connection rods are equally or approximately equally spaced on a circumference of the center region 4211. Through the symmetrical distribution of the four connection rods, it is possible to make the vibration transmission plates bear a balanced force in the working state, thereby prevent the vibration transmission plates from biasing and flipping, which is conducive to increasing a fatigue resistance of the vibration transmission plate.

FIG. 6A is a schematic diagram illustrating a structure of a first vibration transmission plate according to some embodiments of the present disclosure. FIG. 6B is a schematic diagram illustrating a structure of a first vibration transmission plate according to some embodiments of the present disclosure. FIG. 6C is a schematic diagram illustrating a structure of a first vibration transmission plate according to some embodiments of the present disclosure. FIG. 6D is a schematic diagram illustrating a structure of a first vibration transmission plate according to some embodiments of the present disclosure. FIG. 6A-FIG. 6D illustrate various embodiments where the first vibration transmission plate 521 includes a first connection rod 5213 and a second connection rod 5214. In some embodiments, the first connection rod 5213 and the second connection rod 5214 are in a bend structure as shown in FIGS. 5A-6D. In some embodiments, as shown in FIG. 6A, the first connection rod 5213 has 2 bend structures and the second connection rod 5214 has 2 bend structures. As shown in FIG. 6B, the first connection rod 5213 has 3 bend structures, and the second connection rod 5214 has 3 bend structures. As shown in FIG. 6C, the first connection rod 5213 has 3 bend structures and the second connection rod 5214 has 3 bend structures. As shown in FIG. 6D, the first connection rod 5213 has 2 bend structures and the second connection rod 5214 has 2 bend structures. In some embodiments, the first connection rod 5213 and the second connection rod 5214 have the same bend structure, and the first connection rod 5213 and the second connection rod 5214 are symmetrical about the geometric center of the first vibration transmission plate 521. By distributing the first connection rod 5213 and the second connection rod 5214 symmetrically about the geometric center of the first vibration transmission plate 521, it is possible to make the vibration transmission plates subject to a balanced force in a working state, thereby avoiding a deviation and a flipping of the vibration transmission plates, which is conducive to improving the fatigue resistance of the vibration transmission plates when the flipping occurs.

In some embodiments, the first connection rod 5213 and the second connection rod 5214 are distributed along or proximally along the long axis direction of the first vibration transmission plate 521, which compensates for the fatigue resistance of the first vibration transmission plate 521 in the long axis direction, and avoids cracking or fracturing of the vibration transmission plates along the long axis direction.

Table 1 experimentally compares an effect of the distribution manner of the dual vibration transmission plates on its fatigue resistance along the long axis direction, the short axis direction and a vertical axis direction, but the vibration transmission plates are also subjected to flipping forces around the long axis direction and the short axis direction in the working state. Therefore, the fatigue resistances of the vibration transmission plates flipping along the long axis direction and short axis direction have a non-negligible impact on the service life of the vibration transmission plates. When performing a drum experiment, by applying a certain flipping load on the single vibration transmission plate and on the dual-vibration transmission plates (including three connection rods) distributed in the manner shown in FIG. 2 around the long axis direction and the short axis direction, corresponding counts of failure cycles are measured, and specific results are shown in Table 2.

TABLE 2
Count of failure cycles

| | Single | | | | |
|---|---|---|---|---|---|
| | vibration | Distribution | Distribution | Distribution | Distribution |
| | transmission | manner a in | manner b in | manner c in | manner d in |
| | plate | FIG. 3 | FIG. 3 | FIG. 3 | FIG. 3 |
| Flipping | 184 | 1.29 | 1.52 | 1.24 | 2.21 |
| load | | | | | |
| around | | | | | |
| long axis | | | | | |
| Flipping | 9.97 × 10⁴ | 28.9 | 79.9 | 70.2 | 37.7 |
| load | | | | | |
| around | | | | | |
| short | | | | | |
| axis | | | | | |

As may be seen from Table 2, when flipping around the long axis direction and around the short axis direction, the fatigue resistance of the two vibration transmission plates whose projections along the vibration direction overlap, the fatigue resistance of the two vibration transmission plates whose projections along the vibration direction are symmetrical about the long axis direction, the fatigue resistance of the two vibration transmission plates whose projections along the vibration direction are symmetrical along the short axis direction, and the fatigue resistance of the two vibration transmission plates whose projections along the vibration direction are centrally symmetrical are all inferior to the fatigue resistance of the single vibration transmission plate. Although the two vibration transmission plates (including three connection rods) whose projections along the vibration direction are symmetrically distributed improve the fatigue resistance of the vibration transmission plates in the long axis direction, the short axis direction, and the vertical axis direction, the fatigue resistance around the long axis direction and around the short axis direction, especially around the long axis direction, is very poor.

By applying a certain flipping load around the long axis direction and around the short axis direction of two vibration transmission plates including four connection rods whose projections along the vibration direction are symmetrically distributed (such as the vibration transmission plates shown in FIGS. 5A-5B) and around the long axis direction and around the short axis direction of two vibration transmission plates including two connection rods whose projections along the vibration direction are symmetrically distributed (such as the vibration transmission plates shown in FIGS. 6A-6D), the corresponding counts of failure cycles are measured. The count of failure cycles corresponding to the symmetrically distributed dual-vibration transmission plates with two connection rods shown in FIG. 6D is greater than the count of failure cycles corresponding to the symmetrically distributed dual-vibration transmission plates with four connection rods shown in FIGS. 5A-5B, and results of the preferred counts of failure cycles are listed exemplarily, as shown in Table 3.

TABLE 3
Count of failure cycles

| | Vibration | Vibration |
|---|---|---|
| | transmission | transmission |
| | plates shown | plates shown |
| | in FIG. 6C | in FIG. 6D |
| Flipping load | 5.78 × 10² | 20.8 × 10² |
| around the long axis | | |
| Flipping load | 58.4 × 10² | 5.4 × 10² |
| around the short axis | | |

Based on Tables 2 and 3, it may be seen that, in some embodiments, to enhance the fatigue resistance of the vibration transmission plates in the long axis direction and the short axis direction, the two vibration transmission plates whose projections along the vibration direction are symmetrically distributed may both adopt two connection rods that are symmetrically distributed, for example, both vibration transmission plates adopt the two connection rods that are centrally symmetrical as shown in FIGS. 6A-6D. In this way, the fatigue resistance of the vibration transmission plates in the long axis direction, the short axis direction, and the vertical axis direction may be enhanced, and the fatigue resistance of the vibration transmission plates flipping around the long axis direction and the short axis direction may be improved at the same time.

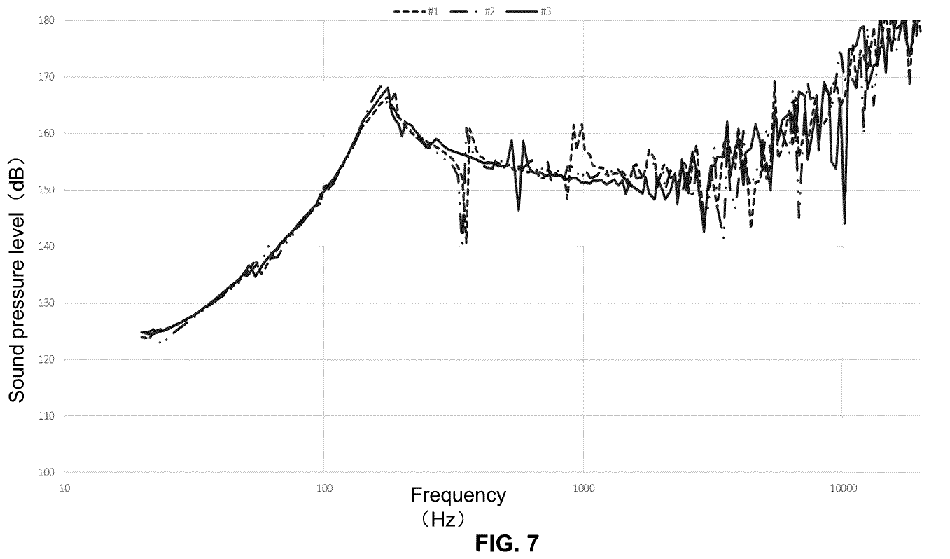

FIG. 7 is a curve diagram illustrating frequency responses of a speaker using the vibration transmission plates shown in FIGS. 6B-6D, respectively. In FIG. 7, curve #1 shows a frequency response curve of the speaker using the vibration transmission plates shown in FIG. 6B, curve #2 shows a frequency response curve of the speaker using the vibration transmission plates shown in FIG. 6C, and curve #3 shows a frequency response curve of the speaker using the vibration transmission plates shown in FIG. 6D. As shown in FIG. 7, a resonance frequency of the speaker with a dual-vibration transmission plate structure including two connection rods is not greater than 300 Hz, which improves the frequency response of the speaker at a low frequency, and at the same time, makes the speaker flatter in a wider band of frequency response curve, to improve a signal-to-noise ratio SNR) of the speaker in a specific frequency band (for example, 300 Hz-5000 Hz). It should be noted that the above frequency response curves are obtained by testing a vibration displacement of the speaker using a Klippel analyzer under a premise of clamping an earhook of the speaker, and converting the vibration displacement into an acceleration (a dB value, with reference to an acceleration of 1E-6 m/s\hat{ }2). A test voltage is 1 Vrms.

In some embodiments, the two vibration transmission plates include a first vibration transmission plate and a second vibration transmission plate, and the first vibration transmission plate and the second vibration transmission plate have the same structure. Each of the first vibration transmission plate and the second vibration transmission plate have a long axis direction and a short axis orientation (i.e., a long axis dimension is greater than a short axis dimension), such as the runway-shaped first vibration transmission plate 321 shown in FIG. 4. To ensure the fatigue resistance of the two vibration transmission plates in different directions (e.g., in the long axis direction, in the short axis direction, in the vertical axis direction, around the long axis direction, and around the short axis direction) and to improve the service life of the two vibration transmission plates, it is necessary to limit stiffness coefficients of the two vibration transmission plates in the long axis direction, in the short axis direction, in the vertical axis direction, flipping around the long axis direction, and flipping around the short axis direction.

In some embodiments, each of the first vibration transmission plate and the second vibration transmission plate has the long axis direction and the short axis direction, and an equivalent stiffness of the first vibration transmission plate and the second vibration transmission plate along the long axis direction is in a range of 7500 N/m-12500 N/m to ensure the fatigue resistances of the first vibration transmission plate and the second vibration transmission plate in the long axis direction, and to prevent the two vibration transmission plates from cracking or fracturing in the long axis direction. A preferred range of the equivalent stiffness of the first vibration transmission plate and the second vibration transmission plate along the long axis direction may include 8,500 N/m-11,500 N/m, 9,000 N/m-10,000 N/m, or 9,500 N/m-10,500 N/m. It is to be noted that the equivalent stiffness of the first vibration transmission plate and the second vibration transmission plate along the long axis direction refers to an ability of the two vibration transmission plates to resist deformations and pull-ups along the long axis direction.

In some embodiments, each of the first vibration transmission plate and the second vibration transmission plate has the long axis direction and the short axis direction, and the equivalent stiffness of the first vibration transmission plate and the second vibration transmission plate in the short axis direction is in a range of 15000 N/m-25000 N/m to ensure the fatigue resistances of the first vibration transmission plate and the second vibration transmission plate along the short axis direction, and to prevent the first vibration transmission plate and the second vibration transmission plate from cracking or fracturing along the short axis direction. A preferred range of equivalent stiffness of the first vibration transmission plate and the second vibration transmission plate along the short axis direction may include 16000 N/m-24000 N/m, 17000 N/m-23000 N/m, 18000 N/m-22000 N/m or 19000 N/m-21000 N/m. It is to be noted that the equivalent stiffness of the first vibration transmission plate and the second vibration transmission plate along the short axis direction refers to an ability of the two vibration transmission plates to resist deformations and pull-ups along the short axis direction.

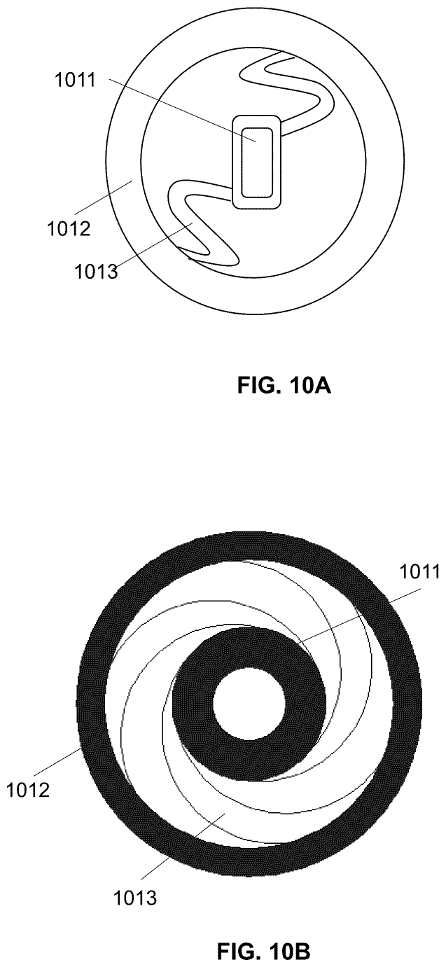

In some embodiments, when the first vibration transmission plate is circular (e.g., an edge region 1012 shown in FIGS. 10A and 10B is annular, with the same long axis dimension and short axis dimension), the equivalent stiffness of the first vibration transmission plate and the second vibration transmission plate along an extension direction of the connection rod is in a range of 10,000 N/m-20,000 N/m to ensure the fatigue resistances of the first vibration transmission plate and the second vibration transmission plate along the extension direction of connection rod, and to prevent the first vibration transmission plate or the second vibration transmission plate from cracking or fracturing in the extension direction of the connection rod. When the first vibration transmission plate and the second vibration transmission plate are circular, a preferred range of equivalent stiffness of the first vibration transmission plate and the second vibration transmission plate in the extension direction of the connection rod may include 11000 N/m-19000 N/m, 12000 N/m-18000 N/m, 13000 N/m-17000 N/m, or 14000 N/m-16000 N/m.

In some embodiments, when the first vibration transmission plate and the second vibration transmission plate are in the runway shape or circular, the equivalent stiffness of the first vibration transmission plate and the second vibration transmission plate in the vertical axis direction (i.e., the vibration direction) is in a range of 1200 N/m-2000 N/m to ensure the fatigue resistances of the first vibration transmission plate and the second vibration transmission plate in the vertical axis direction and to prevent the first vibration transmission plate or the second vibration transmission plate from cracking or fracturing. When the first vibration transmission plate and the second vibration transmission plate are runway-shaped or circular, a preferred range of equivalent stiffness of the first vibration transmission plate and the second vibration transmission plate in the vertical axis direction may include 1300 N/m-1900 N/m, 1400 N/m-1800 N/m, or 1500 N/m-1700 N/m. The equivalent stiffness K of the first vibration transmission plate and the second vibration transmission plate in the vertical axis direction (i.e., the vibration direction) may be obtained from a mass m of the magnetic circuit assembly and a resonance frequency f₀ of the speaker by calculating based on the equation K=m×(2πf₀)².

In some embodiments, the first vibration transmission plate and the second vibration transmission plate each have the long axis direction and the short axis direction, and the equivalent stiffness of the first vibration transmission plate and the second vibration transmission plate when flipping around the long axis is in a range of 0.05-0.15 N*m/rad to ensure the fatigue resistances of the first vibration transmission plate and the second vibration transmission plate when flipping around the long axis direction, and to prevent the first vibration transmission plate or the second vibration transmission plate from cracking or fracturing when flipping around the long axis direction. A preferred range of the equivalent stiffness of the first vibration transmission plate and the second vibration transmission plate when flipping around the long axis direction may include 0.07-0.14 N*m/rad, 0.08-0.12 N*m/rad, or 0.09-0.11 N*m/rad. It should be noted that the equivalent stiffness of the first vibration transmission plate and the second vibration transmission plate when flipping around the long axis direction refers to an ability of the two vibration transmission plates to resist the deformations and pull-ups when flipping around the long axis direction.

In some embodiments, the first vibration transmission plate and the second vibration transmission plate each have the long axis direction and the short axis direction, and the equivalent stiffness of the first vibration transmission plate and the second vibration transmission plate when flipping around the short axis direction is in a range of 0.1-0.2 N*m/rad to ensure the fatigue resistance of the first vibration transmission plate when flipping around the short axis direction, and to prevent the first vibration transmission plate from cracking or fracturing when flipping around the short axis direction. A preferred range of equivalent stiffness of the first vibration transmission plate when flipping around the short axis direction may include 0.12-0.18 N*m/rad, 0.13-0.17 N*m/rad, or 0.14-0.16 N*m/rad. It is noted that the equivalent stiffness of the first vibration transmission plate and the second vibration transmission plate when flipping around the short axis direction refers to an ability of the two vibration transmission plates to resist the deformations and pull-ups when flipping around the short axis direction.

In some embodiments, when the first vibration transmission plate and the second vibration transmission plate are circular, the first vibration transmission plate and the second vibration transmission plate are subjected to an flipping force around an extension direction of the connection rod, and the equivalent stiffness of the first vibration transmission plate and the second vibration transmission plate when flipping around the extension direction of the connection rod is in a range of 0.1 N*m/rad-0.15 N*m/rad, so as to ensure the fatigue resistance of the first vibration transmission plate and the second vibration transmission plate when flipping around the extension direction of the connection rod, and to prevent the first vibration transmission plate or the second vibration transmission plate from cracking or fracturing when flipping around the extension direction of the connection rod. When the first vibration transmission plate and the second vibration transmission plate are circular, a preferred range of the equivalent stiffness of the first vibration transmission plate and the second vibration transmission plate when flipping around the extension direction of the connection rod may include 0.11-0.14 N*m/rad, 0.12-0.135 N*m/rad or 0.125-0.13 N*m/rad. It should be noted that a flip stiffness (i.e., the equivalent stiffness when flipping around the extension direction of the connection rod) of the first vibration transmission plate and the second vibration transmission plate may be calculated by moment=stiffness*angle of rotation (radian system).

FIG. 10A and FIG. 10B are schematic diagrams illustrating structures of vibration transmission plates according to some embodiments of the present disclosure. As shown in FIG. 10 A, the edge region 1012 of the vibration transmission plates is circular, a center region 1011 is located in a hollow region of the edge region 1012. One end of a connection rod 1013 is connected to an outer edge of the center region 1011, and the other end is connected to an inner edge of the edge region 1012. In some embodiments, the connection rod 1013 adopts a meandering bend structure, and the meandering bend structure includes a plurality of bend structures. The bend structures are curved shapes to allow the connection rod to have a preset elasticity coefficient. In some embodiments, the connection rod 1013 has 2 bend structures in a continuous two-bend shape. By adopting the bend structure, the elasticity coefficient of the connection rod in a specific direction (for example, in a radial direction) may be reduced to improve a toughness of the connection rod, and a deformation capacity of the vibration transmission plates may be increased, so as to effectively reduce an impact of a load on the connection rod in the specific direction, and thus improve a service life of the vibration transmission plate. In some embodiments, there are a plurality of connection rods 1013, e.g., two as shown in FIG. 10A. The plurality of connection rods 1013 are symmetrically disposed to enable a magnetic circuit assembly subject to a balanced force when vibrating along the vibration direction, thereby reducing a situation where the magnetic circuit assembly vibrates in a direction deviating from the vibration direction. Referring to FIG. 10B, the connection rod 1013 may be of a curved sheet structure, and there are three connection rods 1013, and the three connection rods 1013 are symmetrical about a center of the vibration transmission plate. It is noted that a count of connection rods is not limited to two and three as described in FIG. 10A and FIG. 10B, which may be more than three. Furthermore, the connection rods are not limited to the bent structure or the curved sheet structure as shown in FIG. 10A and FIG. 10B.

In some embodiments, stiffnesses of the first vibration transmission plate and the second vibration transmission plate in different directions are related to structures (e.g., bending degrees) of the connection rods and distribution positions of the connection rods relative to the center region and the edge region. In some embodiments, stiffness coefficients of the first vibration transmission plate and the second vibration transmission plate are correlated with parameters of the connection rods. For example, the stiffness coefficients of the first vibration transmission plate and the second vibration transmission plate are correlated with a thickness and a width of the connection rods.

In some embodiments, the stiffness coefficients of the two vibration transmission plates in each direction are made to satisfy a limited range by adjusting a width dimension and a thickness dimension of the connection rod. The width dimension of the connection rod is a dimension perpendicular to an extension direction of the connection rod (referring to the dimension A shown in FIG. 4), and the thickness dimension of the connection rod is a dimension of the connection rod in a vertical axis direction (i.e., the vibration direction). In some embodiments, a width of the each connection rod is in a range of 0.2 mm-0.66 mm. A preferred range for the width of the each connection rod may include 0.3 mm-0.52 mm. In some embodiments, the thickness of each connection rod is in a range of 0.1 mm-0.15 mm. In some embodiments, the stiffness coefficient of the connection rods is increased by adjusting the width dimension and the thickness dimension of the connection rods, so that the stiffness of the first vibration transmission plate and the second vibration transmission plate in each direction satisfies a defined range, and resonance peaks generated by the first vibration transmission plate and the second vibration transmission plate vibrating with the magnetic circuit assembly 110 satisfy a specific range. In some embodiments, the vibration of the first vibration transmission plate and the second vibration transmission plate driven by the magnetic circuit assembly 110 generates a resonance peak of no more than 300 Hz, which simultaneously improves the frequency response of the speaker 100 at low frequencies, and enables the speaker 100 to have a flatter frequency response curve in a wider frequency band, thereby improving the SNR of the speaker 100.

In some embodiments, the stiffness coefficients of the first vibration transmission plate and the second vibration transmission plate are also related to own materials thereof. In some embodiments, the material of the two vibration transmission plates is beryllium copper, stainless steel, etc.

In some embodiments, the width dimension of the connection rods changes in its extension direction. As shown in FIG. 4, taking the first connection rod 3213 as an example for illustration, the first connection rod 3213 includes a first portion 32131 connecting the center region 3211, a second portion 32133 connecting the edge region 3212, and a third portion 32132 disposed between the first portion 32131 and the second portion 32133. In a working state of the vibration transmission plate, stresses of the first portion 32131 connected to the center region 3211 and the second portion 32133 connected to the edge region 3212 are relatively concentrated, and to ensure a structural stability of the connection rod and to prevent the portion 32131 and the second portion 32133 from cracking or fracturing, the stiffness coefficients of the first portion 32131 and the second portion 32133 of the connection rod may be increased. In some embodiments, widths of the first portion 32131 and the second portion 32133 may be greater than a width of the third portion 32132 to improve stiffness coefficients of the first portion 32131 and the second portion 32133 of the connection rod 32133, thereby enhancing a structural strength between the connection rod and the center region 3211 and the edge region 3212. The widths of the different regions of the connection rod are different, and taking the first connection rod 3213 as an example, the resonance frequency of the speaker is mainly negatively correlated with the width of the third portion 32132, e.g., the larger the width of the third portion 32132, the smaller the resonant frequency of the speaker, and the fatigue resistance of the speaker is positively correlated with the width of the connection rod, so in order to prevent the resonant frequency of the speaker from being too high, and to ensure the fatigue resistance of the speaker, the width of the third portion 32132 may not be too great or too small. Based on this, in some embodiments, the width of the third portion 32132 is in a range of 0.2 mm-0.66 mm, so as to make the resonance frequency of the speaker not greater than 300 Hz, and at the same time to ensure the fatigue resistance of the vibration transmission plates and improve the service life of the vibration transmission plate.

Continuing to refer to FIG. 1 and FIG. 2, in some embodiments, the magnetic circuit assembly 110 includes a first magnet 111, a magnetic conduction plate 112, a second magnet 113, and a magnetic conduction shield 114 disposed in sequence along the vibration direction as indicated in FIG. 2. In some embodiments, the first magnet 111 and the second magnet 113 are connected to opposing sides of the magnetic conduction plate 112 along the vibration direction, respectively. In some embodiments, the magnetic conduction shield 114 is disposed on a side of the second magnet 113 away from the first magnet 111, and the magnetic conduction shield 114 surrounds the first magnet 111, the magnetic conduction plate 112, and the second magnet 113 along the vibration direction (i.e., a bottom surface of a groove of the magnetic conduction shield 114 is connected to the side of the second magnet 113 that is away from the first magnet 111). In some embodiments, the speaker 100 further includes a coil 140. The coil 140 extends into a gap between the first magnet 111 and the magnetic conduction shield 114 along the vibration direction from a side away from the magnetic conduction shield 114. A magnetic field generated by the coil 140 after it is energized interacts with a magnetic field formed by the magnetic circuit assembly 110, thereby driving the magnetic circuit assembly 110 to generate mechanical vibrations.

In some embodiments, the two vibration transmission plates of the speaker 100 include the first vibration transmission plate 121 and the second vibration transmission plate 122 (hereinafter referred to as the vibration transmission plates). The first vibration transmission plate 121 and the second vibration transmission plate 122 have the same structure. The vibration transmission plates may be the first vibration transmission plate (e.g., the first vibration transmission plate 321, 421, or 521) as provided in any embodiment of the present disclosure. In some embodiments, the first vibration transmission plate 121 is disposed on the side of the first magnet 111 that is away from the second magnet 113 to support the magnetic circuit assembly 110, and the second vibration transmission plate 122 is disposed on the side of the second magnet 113 that is away from the first magnet 111 to support the magnetic circuit assembly 110. In some embodiments, a center region of the first vibration transmission plate 121 is connected to the side of the first magnet 111 that is away from the second magnet 113, and a center region of the second vibration transmission plate 122 is connected to the side of the second side of the magnet 113 that is away from the first magnet 111. Two projections of the first vibration transmission plate 121 and the second vibration transmission plate 122 along the vibration direction may overlap, may be symmetrical along the long axis direction, may be symmetrical along the short axis direction, or may be centrally symmetrical (e.g., the four distributions illustrated in FIG. 3).

In some embodiments, the vibration transmission plates and the magnetic circuit assembly 110 are disposed within an accommodation cavity of the housing 131. In some embodiments, the vibration transmission plates are directly connected to the housing 131. For example, the edge region of the vibration transmission plates is connected circumferentially to an inner wall of the housing 131 by one or more of a snap-fit, a glue bonding, etc. As another example, the housing 131 is a structure with an opening, and the edge region of the vibration transmission plates is disposed in the opening on the housing 131, and the opening is covered with a cover plate to achieve a fixation of the edge region of the vibration transmission plates and the housing 131. The center region of the vibration transmission plates is configured to connect the magnetic circuit assembly 110, e.g., the center region is connected to the magnetic circuit assembly 110 by means of bonding, soldering, threaded connection, etc. In some embodiments, the center region of the first vibration transmission plate 121 is provided with a first connection member 150 on a side near the magnetic circuit assembly 110, and the center region of the second vibration transmission plate 122 is provided with a second connection member 151 on a side near the magnetic circuit assembly 110. The first connection member 150, the second connection member 151, and the magnetic circuit assembly 110 are fixedly connected by a screw 160, thereby realizing the connection between the center region of the vibration transmission plates and the magnetic circuit assembly 110. In some embodiments, the center regions of the first connection member 150 and the second connection member 151 are provided with threaded holes, and two ends of the screw 160 are respectively connected to the threaded holes in the center regions of the first connection member 150 and the second connection member 151 by threaded fits. When the magnetic circuit assembly 110 vibrates, the vibration may be transmitted to the housing 131 through the vibration transmission plates, which is ultimately transmitted to auditory nerves of a user, so as to enable the user to hear sound. It should be noted that the connection from the first connection member 150 and the second connection member 151 to the center region of the vibration transmission plates is not limited to the threaded connection as described above, but may also be welded, adhesive, overfitting, etc. The manner of connecting the first connection member 150 to the first vibration transmission plate 121 and the manner of connecting the second connection member 151 to the second vibration transmission plate 122 may be the same or different. For example, the first connection member 150 is connected to the center region of the first vibration transmission plate 121 by means of threaded connection, and the second connection member 151 is connected to the center region of the second vibration transmission plate 122 by means of welded connection.

The speaker 100, by adopting dual-vibration transmission plates to support the magnetic circuit assembly 110 from both sides of the magnetic circuit assembly 110 along the vibration direction, is able to reduce a sway of the magnetic circuit assembly 110 away from the vibration direction that occurs when the magnetic circuit assembly 110 vibrates. Accordingly, an impact of the sway of the magnetic circuit assembly 110 on the vibration transmission plates is reduced, thereby reducing an amplitude of the vibration transmission plates flipping around the long axis direction or the short axis direction, so that a time before the vibration transmission plates to break and be damaged is substantially extended, and the service life of the vibration transmission plates is ensured.

In some embodiments, the magnetic circuit assembly 110 collides with the vibration transmission plates during vibration, which affects an acoustic performance of the speaker 100 and the service life of the vibration transmission plate. To avoid the collision of the magnetic circuit assembly 110 and the vibration transmission plates along the vibration direction, a distance B (refer to FIG. 2) between two opposite side surfaces of the first magnet 111 and the first vibration transmission plate 121 is not less than 0.9 mm. Similarly, a distance C (refer to FIG. 2) between two opposite side surfaces of the magnetic conduction shield 114 and the second vibration transmission plate 122 is not less than 0.9 mm. In some embodiments, to make a dimension of the speaker 100 as small as possible to improve a portability of the speaker 100 and to avoid the collision between the magnetic circuit assembly 110 and the vibration transmission plate, the distance B and the distance C are in a range of 0.9 mm-1.8 mm. In some embodiments, the distance B and the distance C may be in a range of 0.9 mm-1.6 mm. In some embodiments, the distance B and the distance C may be in a range of 0.9 mm-1.4 mm.

By limiting the distance between the magnetic circuit assembly 110 and the vibration transmission plate, the magnetic circuit assembly 110 may be avoided from colliding with the vibration transmission plates during vibration, thereby ensuring the acoustic performance of the speaker 100 and the service life of the vibration transmission plate.

Referring to FIG. 2, in some embodiments, the magnetic path assembly 110 also collides with a bracket (e.g., a first bracket 132), the coil 140, or the housing 131 during vibration along a direction deviating from the vibration direction, and to avoid the collision between the magnetic conduction shield 114 of the magnetic circuit assembly 110 and the coil 140 and the collision between the magnetic circuit assembly 110 and the bracket in a direction perpendicular to the vibration direction, a distance D (also referred to as an inner magnetic gap) between a magnetic element (e.g., the first magnet, the magnetic conduction plate, and the second magnet) and the first bracket 132 and a distance D (also referred to as an outer magnetic gap) between the magnetic conduction shield 114 and the coil 140 along the direction perpendicular to the vibration direction are not less than 0.3 mm. To avoid collision between the magnetic conduction shield 114 of the magnetic circuit assembly 110 and the housing 131, in the direction perpendicular to the vibration direction, a distance E (refer to FIG. 2) between the two opposite side surfaces of the magnetic conduction shield 114 and the housing 131 is not less than 0.3 mm. In some embodiments, to make the dimension of the speaker 100 as small as possible to improve the portability of the speaker 100 while avoiding the collision between the magnetic circuit assembly 110 and the coil 140 or the housing 131, the distance D and the distance E are in a range of 0.3 mm-1 mm. In some embodiments, the distance D and distance E may be in a range of 0.3 mm-0.8 mm. In some embodiments, the distance D and the distance E may be in a range of 0.3 mm-0.6 mm.

In some embodiments, combining FIG. 1 and FIG. 2, the support portion 130 further includes the first bracket 132 and a second bracket 133. The first bracket 132 and the second bracket 133 are disposed at intervals along the vibration direction and are fixedly connected to the housing 131. The first bracket 132 and the second bracket 133 provide a mounting platform for the first vibration transmission plate 121 and the second vibration transmission plate 122, respectively, while the first bracket 132 also provides a mounting platform for the coil 140. In some embodiments, the edge region of the first vibration transmission plate 121 and the coil 140 are fixed to the first bracket 132, and the edge region of the second vibration transmission plate 122 is fixed to the second bracket 133. In some embodiments, a part of the edge region of the first vibration transmission plate 121 (e.g., a part proximate its circumferential side) is embedded in the first bracket 132, and a side surface of the coil 140 proximate to the magnetic circuit assembly 110 is connected to the first bracket 132. In some embodiments, the coil 140 is fixed to the housing 131 or the first bracket 132 in other manners. For example, the coil 140 is directly connected to the inner wall of the housing 131 through the connection rod. As another example, the first bracket 132 does not extend into the magnetic gap between the magnetic conduction shield 114 and the magnetic elements (e.g., the first magnet, the magnetic conduction plate, and the second magnet), one end of the coil 140 is connected to the first bracket 132, and the other end of the coil 140 extends into the magnetic gap. A part of the edge region of the second vibration transmission plate 122 (e.g., a portion proximate to a circumferential side of the second vibration transmission plate 122) is embedded in the second bracket 133.

A consistency of the vibration of the vibration assembly may be ensured by disposing the first bracket 132 to fix the first vibration transmission plate 121 and the coil 140, and at the same time, by disposing the second bracket 133 to fix the second vibration transmission plate 122, a structure stability between the coil 140, the vibration transmission plates, and the magnetic circuit assembly 110 may be improved, so as to ensure that the coil 140, the vibration transmission plate, and the magnetic circuit assembly 110 operate reliably during a long-term working process of the speaker 100.

One end of the magnetic circuit assembly 110 provided with the magnetic conduction shield 114 is regarded as a bottom of the magnetic circuit assembly 110, a center of gravity of the magnetic circuit assembly 110 is nearer to the bottom of the magnetic circuit assembly 110 due to the provision of the magnetic conduction shield 114 at the bottom of the magnetic circuit assembly 110. In some embodiments, a hardness of the second vibration transmission plate 122 near the bottom of the magnetic circuit assembly 110 is greater than a hardness of the first vibration transmission plate 121 away from the bottom of the magnetic circuit assembly 110, to enable the second vibration transmission plate 122 to adapt to a sway with a greater magnitude at a region of the magnetic circuit assembly 110 near the bottom region thereof, which is conducive to reducing the sway of the magnetic circuit assembly 110 when vibrating along the vibration direction, and at the same time to prevent a tilting of the magnetic circuit assembly 110. In some embodiments, a Young's modulus of the second vibration transmission plate 122 is greater than a Young's modulus of the first vibration transmission plate 121, thereby realizing that the hardness of the second vibration transmission plate 122 is greater than the hardness of the first vibration transmission plate 121. For example, a material of the second vibration transmission plate 122 is stainless steel with a higher Young's modulus, and a material of the first vibration transmission plate 121 is beryllium copper with a lower Young's modulus. To make the second vibration transmission plate 122 be able to adapt to a greater sway of the magnetic circuit assembly 110 near the bottom region thereof, and to reduce the sway of the magnetic circuit assembly 110 when vibrating along the vibration direction, and at the same time to prevent the magnetic circuit assembly 110 from tilting, in some embodiments, a ratio of the Young's modulus of the second vibration transmission plate 122 to the Young's modulus of the first vibration transmission plate 121 is in a range of 1-1.5.

By setting the hardness of the second vibration transmission plate 122 greater than the hardness of the first vibration transmission plate 121, the second vibration transmission plate 122 may adapt to a sway of the magnetic circuit assembly 110 with a greater magnitude and a greater weight near the bottom region thereof, and ensure that the first vibration transmission plate 121 and the second vibration transmission plate 122 converge in service life. At the same time, the magnetic circuit assembly 110 is prevented from tilting, which is conducive to reducing the sway of the magnetic circuit assembly 110 when it vibrates along the vibration direction.

In some embodiments, two projections of the first vibration transmission plate 121 and the second vibration transmission plate 122 along the vibration direction included in the speaker 100 may be asymmetrically distributed, at which point other parts of the speaker 100 (e.g., the support portion 130 and the magnetic circuit assembly 110) are referred to in FIGS. 1 and 2 and related descriptions thereof.

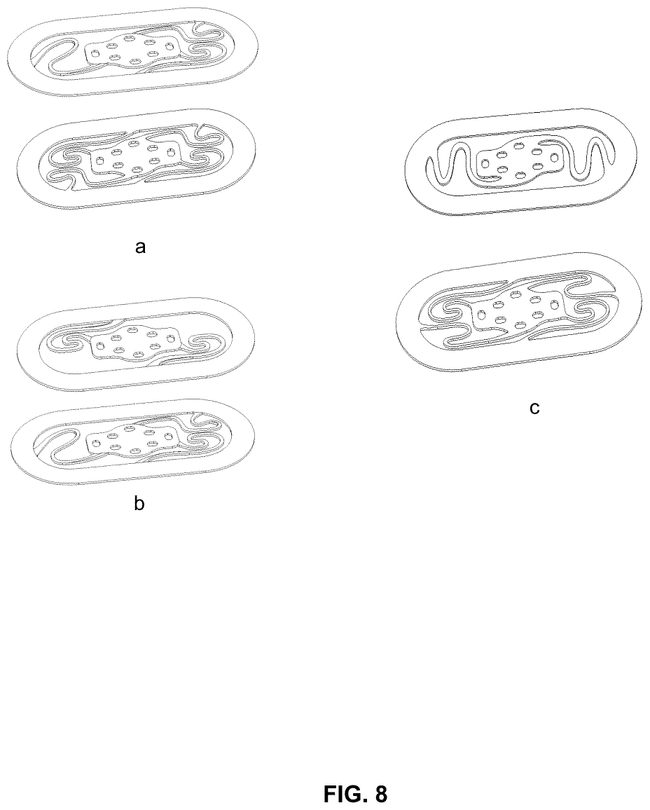

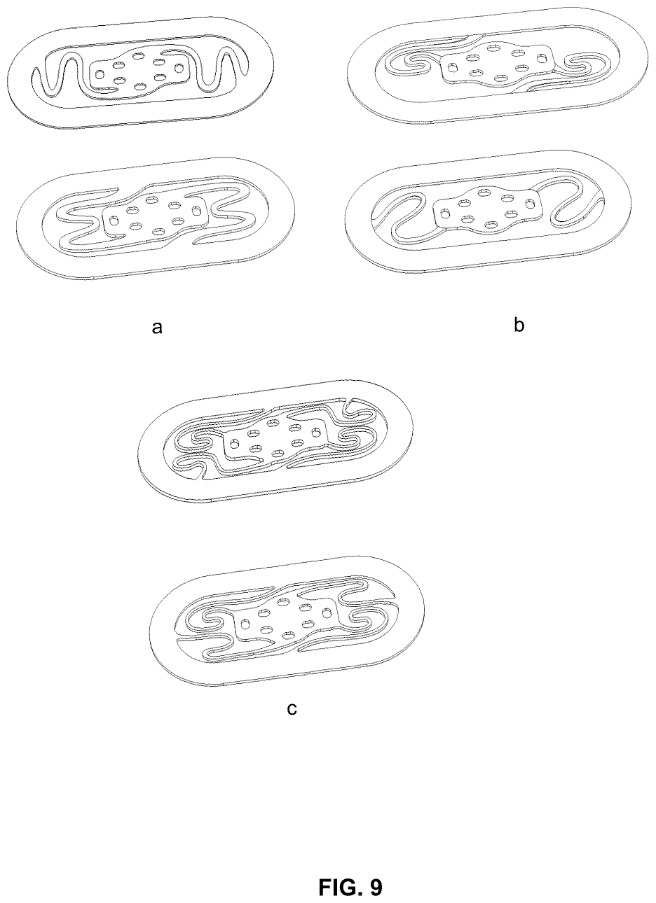

In some embodiments, when the two projections of the two vibration transmission plates are asymmetrically distributed along the vibration direction, the two vibration transmission plates have different structures. In some embodiments, shapes of the two vibration transmission plates with different structures are different, for example, the first vibration transmission plate 121 is a circular vibration transmission plate, and the second vibration transmission plate 122 is a runway-shaped vibration transmission plate. In some embodiments, the two vibration transmission plates with different structures include different counts and/or structures of the connection rods. FIG. 8 is a schematic diagram illustrating three distributions of vibration transmission plates according to some embodiments of the present disclosure. FIG. 9 is a schematic diagram illustrating three distributions of vibration transmission plates according to some embodiments of the present disclosure. a, b, and c in FIG. 8 show a variety of embodiments where two structurally different vibration transmission plates include different counts of connection rods. a, b, and c in FIG. 9 show a variety of embodiments where two structurally different vibration transmission plates include connection rods with different structures. The first vibration transmission plate 121 or the second vibration transmission plate 122 may be any one of those illustrated in FIG. 4-FIG. 6D.

In some embodiments, when two projections of the two vibration transmission plates along the vibration direction are asymmetrically distributed, the two vibration transmission plates are two vibration transmission plates with the same structure, but the two vibration transmission plates are arranged at different angles. In some embodiments, taking a runway-shaped vibration transmission plate as an example, the vibration transmission plate has a long axis direction and a short axis direction, and the long axis direction of the first vibration transmission plate 121 is arranged at a certain angle to the long axis direction of the second vibration transmission plate 122, so that the two vibration transmission plates are arranged at different angles. For example, the long axis direction of the first vibration transmission plate 121 is set perpendicularly to the long axis direction of the second vibration transmission plate 122, and an inner edge of an edge region of the first vibration transmission plate 121 is disposed on an outer edge of an edge region of the second vibration transmission plate 122, and a center region of the first vibration transmission plate 121 doses not contact a center region of the second vibration transmission plate 122, and the magnetic circuit assembly is disposed in the center region of the first vibration transmission plate 121 or the center region of the second vibration transmission plate 122.

The asymmetrically distributed first vibration transmission plate 121 and second vibration transmission plate 122 are located on opposite sides of the magnetic circuit assembly 110 along the vibration direction, and the vibration of the magnetic circuit assembly 110 is limited by the vibration transmission plates on the both sides. On the one hand, a sway in the vibration of the magnetic circuit assembly 110 is reduced, on the one hand, the sway of the magnetic circuit assembly 110 is reduced by setting the dual-vibration transmission plates, and an amplitude of the vibration transmission plates folding in the long axis direction or in the short axis direction is reduced, so that a time before the vibration transmission plates is damaged and fractured is extended substantially, and a service life of the vibration transmission plates is ensured. Specific descriptions of the first vibration transmission plate 121 and the second vibration transmission plate 122 may be found in the relevant descriptions of the vibration transmission plates in the previous sections (e.g., FIG. 1, FIGS. 4-6D), which are not repeated herein.

In some embodiments, the first vibration transmission plate 121 is disposed away from the magnetic conduction shield 114 of the magnetic circuit assembly 110, and the second vibration transmission plate 122 is disposed close to the magnetic conduction shield 114 of the magnetic circuit assembly 110. A center of gravity of the magnetic circuit assembly 110 is closer to the bottom of the magnetic circuit assembly 110 due to a presence of the magnetic conduction shield 114 disposed at the bottom of the magnetic circuit assembly 110. That is, along the vibration direction, a distance between the center of gravity of the magnetic circuit assembly 110 and the second vibration transmission plate 122 is smaller than a distance between the center of gravity of the magnetic circuit assembly 110 and the first vibration transmission plate 121. Therefore, the second vibration transmission plate 122 needs greater stiffness and hardness compared to the first vibration transmission plate 121 to counteract flipping and fatigue.

In some embodiments, the hardness of the second vibration transmission plate 122 is greater than that of the first vibration transmission plate 121 to enable the second vibration transmission plate 122 to adapt to a sway with a greater magnitude of the magnetic circuit assembly 110 at a region close to the bottom of the magnetic circuit assembly 110, which is conducive to reducing the sway of the magnetic circuit assembly 110 when vibrating along the vibration direction, and at the same time preventing the magnetic circuit assembly 110 from tilting. In some embodiments, the width of the connection rod of the second vibration transmission plate 122 may be greater than the width of the connection rod of the first vibration transmission plate 121, realizing that the hardness of the second vibration transmission plate 122 is greater than the hardness of the first vibration transmission plate 121.

By making the width of the connection rod of the second vibration transmission plate 122 greater than the width of the connection rod of the first vibration transmission plate 121, the hardness of the second vibration transmission plate 122 is made greater than the hardness of the first vibration transmission plate 121, so that the second vibration transmission plate 122 is adapted to a sway with a greater magnitude and a greater weight of the magnetic circuit assembly 110 at the region close to the bottom of the magnetic circuit assembly 110, to ensure that the service lives of the first vibration transmission plate 121 and the second vibration transmission plate 122 tend to be the same, and at the same time to prevent the magnetic circuit assembly 110 from tilting, which is conducive to reducing the sway of the magnetic circuit assembly 110 when vibrating along the vibration direction.

In some embodiments, the vibration transmission plates vibrate with the magnetic circuit assembly 110 and generate a resonance peak of no more than 300 Hz (e.g., 150 Hz-250 Hz), which improves a frequency response of the speaker 100 at low frequencies, and at the same time allows the speaker 100 to have a flatter frequency response curve over a wider frequency band, thereby improving an SNR of the speaker 100. In some embodiments, the thickness and the width of the connection rod of the vibration transmission plates are adjusted to make the second vibration transmission plate 122 generate a resonance peak of no more than 300 Hz when vibrates with the magnetic circuit assembly 110. However, adjusting the width dimension and the thickness dimension of the connection rod of the vibration transmission plates affects a frequency of the resonance peak generated by the vibration of the vibration transmission plates with the magnetic circuit assembly 110. To ensure that the second vibration transmission plate 122 generates a resonance peak not exceeding 300 Hz when vibrates with the magnetic circuit assembly 110, when making the width of the connection rod of the second vibration transmission plate 122 greater than the width of the connection rod of the first vibration transmission plate 121, the thickness of the connection rod of the second vibration transmission plate 122 may be made smaller than the thickness of the connection rod of the first vibration transmission plate 121, which improves the frequency response of the second vibration transmission plate 122 at low frequencies, and at the same time allows the speaker 100 to have a relatively flat frequency response curve in a wider frequency band, and improves the SNR of the speaker 100. It is known that by increasing the thickness of the connection rod of the second vibration transmission plate 122 while decreasing the width of the connection rod of the second vibration transmission plate 122, the sway of the magnetic circuit assembly 110 when vibrating along the vibration direction is reduced, and at the same time, it is ensured that the second vibration transmission plate 122 vibrates with the magnetic circuit assembly 110 to generate a resonance peak of no more than 300 Hz. However, increasing the width of the connection rod of the second vibration transmission plate 122 is more conducive to reducing the sway of the magnetic circuit assembly 110 when vibrating along the vibration direction. Therefore, priority may be given to increasing the width of the connection rod of the second vibration transmission plate 122 while decreasing the thickness of the connection rod of the second vibration transmission plate 122.

By making the width of the connection rod of the second vibration transmission plate 122 greater than the width of the connection rod of the first vibration transmission plate 121, and making the thickness of the connection rod of the second vibration transmission plate 122 smaller than the thickness of the connection rod of the first vibration transmission plate 121, the magnetic circuit assembly 110 may be prevented from tilting, which is conducive to reducing the sway of the magnetic circuit assembly 110 when vibrating along the vibration direction, improving the frequency response of the speaker 100 at low frequencies, and making the frequency response curve of the speaker 100 relatively flat in a wider frequency band.

In some embodiments, the hardness of the second vibration transmission plate 122 is made greater than that of the first vibration transmission plate 121 by making a count of connection rods of the second vibration transmission plate 122 greater than a count of connection rods of the first vibration transmission plate 121, which is conducive to reducing the sway of the magnetic circuit assembly 110 when vibrating along the vibration direction, while preventing the magnetic circuit assembly 110 from tilting.

In some embodiments, as shown in a in FIG. 8, there are four connection rods included in the second vibration transmission plate 122, and there are three connection rods included in the first vibration transmission plate 121. In some embodiments, there are three connection rods included in the second vibration transmission plate 122 and two connection rods included in the first vibration transmission plate 121, as shown in b in FIG. 8. In some embodiments, there are four connection rods included in the second vibration transmission plate 122 and two connection rods included in the first vibration transmission plate 121, as shown in c in FIG. 8.

In some embodiments, the Young's modulus of the material of the second vibration transmission plate 122 is greater than the Young's modulus of the material of the first vibration transmission plate 121, so as to make the hardness of the second vibration transmission plate 122 greater than the hardness of the first vibration transmission plate 121, which helps to reduce the sway of the magnetic circuit assembly 110 when vibrating along the vibration direction, and preventing the magnetic circuit assembly 110 from tilting.

The basic concepts have been described above, and it is apparent to those skilled in the art that the foregoing detailed disclosure serves only as an example and does not constitute a limitation of the present disclosure. While not expressly stated herein, those skilled in the art may make various modifications, improvements, and amendments to the present disclosure. Those types of modifications, improvements, and amendments are suggested in the present disclosure, so those types of modifications, improvements, and amendments remain within the spirit and scope of the exemplary embodiments of the present disclosure.

What is claimed is:

1. A speaker, comprising:
a support portion, a magnetic circuit assembly, and a positioning assembly, wherein
the magnetic circuit assembly is connected to the support portion through the positioning assembly, and the magnetic circuit assembly vibrates relative to the support portion; and
the positioning assembly includes two vibration transmission plates spaced apart in a vibration direction of the magnetic circuit assembly, and projections of the two vibration transmission plates along the vibration direction are symmetrical with each other.

2. The speaker of claim 1, wherein the two vibration transmission plates include a first vibration transmission plate, the first vibration transmission plate includes a center region, an edge region, and at least one connection rod connecting the center region and the edge region, the at least one connection rod includes a first portion connecting the center region, a second portion connecting the edge region, and a third portion disposed between the first portion and the second portion, and widths of the first portion and the second portion are greater than a width of the third portion.

3. The speaker of claim 2, wherein the at least one connection rod includes two connection rods symmetrical about a center of the first vibration transmission plate.

4. The speaker of claim 2 or 3, wherein a thickness of the at least one connection rod is in a range of 0.1 mm-0.15 mm.

5. The speaker of claim 2 or 3, wherein the width of the third portion of the at least one connection rod is in a range of 0.2 mm-0.66 mm.

6. The speaker of any one of claims 2-5, wherein the two vibration transmission plates further include a second vibration transmission plate, and the first vibration transmission plate and the second vibration transmission plate both have a long axis direction and a short axis direction.

7. The speaker of claim 6, wherein an equivalent stiffness of the first vibration transmission plate and the second vibration transmission plate along the long axis direction is in a range of 7,500 N/m-12,500 N/m.

8. The speaker of claim 6, wherein an equivalent stiffness of the first vibration transmission plate and the second vibration transmission plate along the short axis direction is in a range of 15,000 N/m-25,000 N/m.

9. The speaker of claim 6, wherein an equivalent stiffness of the first vibration transmission plate and the second vibration transmission plate along the vibration direction is in a range of 1200 N/m-2000 N/m.

10. The speaker of claim 6, wherein an equivalent stiffness of the first vibration transmission plate and the second vibration transmission plate flipping around the long axis direction is in a range of 0.05-0.15 N*m/rad.

11. The speaker of claim 6, wherein an equivalent flipping stiffness of the first vibration transmission plate and the second vibration transmission plate flipping around the short axis direction is in a range of 0.1-0.2 N*m/rad.

12. The speaker of claim 6, wherein the projections of the first vibration transmission plate and the second vibration transmission plate are symmetrical about the short axis direction.

13. The speaker of claim 6, wherein the projections of the first vibration transmission plate and the second vibration transmission plate are symmetrical about the long axis direction.

14. The speaker of claim 6, wherein the projections of the first vibration transmission plate and the second vibration transmission plate are centrally symmetrical.

15. The speaker of claim 1, wherein the magnetic circuit assembly includes a first magnet, a magnetic conduction plate, a second magnet, and a magnetic conduction shield disposed in sequence along the vibration direction, the two vibration transmission plates include a first vibration transmission plate and a second vibration transmission plate, the first vibration transmission plate is located on a side of the first magnet that is away from the second magnet, and the second vibration transmission plate is located on a side of the magnetic conduction shield that is away from the second magnet.

16. The speaker of claim 15, wherein along the vibration direction, a distance between two side surfaces of the first magnet and the first vibration transmission plate opposite to each other is not less than 0.9 mm, and a distance between two side surfaces of the magnetic conduction shield and the second vibration transmission plate opposite to each other is not less than 0.9 mm.

17. The speaker of claim 15 or 16, wherein the magnetic circuit assembly drives the positioning assembly to vibrate, and a resonant frequency generated by the positioning assembly is no more than 300 Hz.

18. The speaker of claim 2, wherein the two vibration transmission plates further include a second vibration transmission plate, and the support portion includes a housing, a first bracket and a second bracket for connecting the first vibration transmission plate and the second vibration transmission plate to the housing, respectively;
the edge region of the first vibration transmission plate is fixed to the first bracket, and a coil of the speaker is fixed to the first bracket; and
an edge region of the second vibration transmission plate is fixed to the second bracket.

19. The speaker of claim 18, wherein a Young's modulus of the second vibration transmission plate is greater than a Young's modulus of the first vibration transmission plate.

20. The speaker of claim 2, wherein the edge region of the first vibration transmission plate is circular, and an equivalent stiffness of the two vibration transmission plates along an extension direction of the at least one connection rod is in a range of 10000 N/m-20000 N/m.

21. The speaker of claim 2, wherein the edge region of the first vibration transmission plate is circular, and an equivalent stiffness of the two vibration transmission plates along the vibration direction is in a range of 1200 N/m-2000 N/m.

22. The speaker of claim 2, wherein the edge region of the first vibration transmission plate is circular, and an equivalent flipping stiffness of the first vibration transmission plate and the second vibration transmission plate flipping around an extension direction of the at least one connection rod is in a range of 0.1 N*m/rad-0.15 N*m/rad.

23. A speaker, comprising:
a support portion, a magnetic circuit assembly, and a positioning assembly, wherein
the magnetic circuit assembly is connected to the support portion through the positioning assembly, and the magnetic circuit assembly vibrates relative to the support portion; and
the positioning assembly includes two vibration transmission plates spaced apart along a vibration direction of the magnetic circuit assembly, and projections of the two vibration transmission plates along the vibration direction are asymmetrical with each other.

24. The speaker of claim 23, wherein the two vibration transmission plates include a first vibration transmission plate and a second vibration transmission plate located on opposite sides of the magnetic circuit assembly, and a width of a connection rod of the second vibration transmission plate is greater than a width of a connection rod of the first vibration transmission plate.

25. The speaker of claim 24, wherein a thickness of the connection rod of the second vibration transmission plate is less than a thickness of the connection rod of the first vibration transmission plate.

26. The speaker of claim 24 or 25, wherein a count of connection rods of the second vibration transmission plate is different from a count of connection rods of the first vibration transmission plate.

27. The speaker of claim 26, wherein the count of the connection rods of the second vibration transmission plate is greater than the count of the connection rods of the first vibration transmission plate.

28. The speaker of claim 24, wherein a Young's modulus of the second vibration transmission plate is greater than a Young's modulus of the first vibration transmission plate.

29. The speaker of claim 24, wherein the magnetic circuit assembly includes a first magnet, a magnetic conduction plate, a second magnet, and a magnetic conduction shield disposed in sequence along the vibration direction, and the first vibration transmission plate is disposed on a side of the first magnet that is away from the magnetic conduction plate, and the second vibration transmission plate is disposed on a side of the magnetic conduction shield that is away from the second vibration transmission plate; wherein along the vibration direction, a distance between two side surfaces the first magnet and the first vibration transmission plate opposite to each other is not less than 0.9 mm, and a distance between two side surfaces of the magnetic conduction shield and the second vibration transmission plate opposite to each other is not less than 0.9 mm.

30. The speaker of claim 24 or 29, wherein the magnetic circuit assembly drives the positioning assembly to vibrate, and a resonant frequency generated by the positioning assembly is no more than 300 Hz.

31. The speaker of any one of claims 25-28, wherein along the vibration direction, a distance between a center of gravity of the magnetic circuit assembly and the second vibration transmission plate is less than a distance between the center of gravity of the magnetic circuit assembly and the first vibration transmission plate.
